(19) United States
(12) Patent Application Publication
(10) Pub. No.: US 2007/0234566 A1
(43) Pub. Date: Oct. 11, 2007

(54) Method for adhering a heat pipe wall and a wick structure

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/393,924

(22) Filed: Mar. 31, 2006

(51) Int. Cl. B21D 53/02; B23P 6/00

(52) U.S. Cl. 29/890.03; 29/890.032

(57) ABSTRACT

A method for adhering a heat pipe wall and a wick structure includes the steps of preparing at least one layer of wick structure; attaching an appropriate amount of metal powder on the wick structure; placing the wick structure into a hollow heat pipe body; supporting the wick structure at an internal wall of the pipe body; sintering the metal powder as an adhesive for the pipe body and the wick structure, so that the wick structure is adhered onto the internal wall of the pipe body by the metal powder, while fibers of the wick structure are cohered with each other by the metal powder to enhance the effect of adhering the wick structure onto the pipe wall without affecting the original capillary attraction and transmission of the wick structure.

### BACKGROUND OF THE INVENTION

1. Field of the Invention

The present invention relates to a method for adhering a heat pipe wall and a wick structure, and more particularly to a method that sinters a metal powder and uses the sintered metal power as an adhesive for a heat pipe wall and a wick structure to enhance the effect of adhering the wick structure onto the pipe wall.

2. Description of Prior Art

Since a heat pipe has the features of a high thermal conducting capability, a quick thermal conduction, a high thermal conductivity, a light weight, free of passive components, a simple structure, and multipurpose, therefore the heat pipe can conduct a great deal of heat without consuming much electric power and the heat pipe is applicable for the heat dissipation of electronic products. In general, a heat pipe wall usually installs a wick structure, and the wick structure comprises meshes or fibers with a capillary effect, so that the capillary effect of the wick structure can be used for transmitting a working fluid in a heat pipe.

The process of forming the wick structure on the heat pipe in the past usually goes through a sintering process to adhere the wick structure onto an internal wall of a pipe body of the heat pipe, but the adhering effect is poor since the materials of the wick structure comprising meshes or fibers are softened and then the wick structure is adhered onto the internal wall of a pipe body during the sintering process, and thus the wick structure may come off easily and seriously affect the transmission of the working fluid. Further, the wick structure cannot be attached onto the pipe wall by an adhesive such as a solder paste, and for the worst cases, the capillary attraction and transmission may be disabled.

### SUMMARY OF THE INVENTION

In view of the foregoing shortcomings of the prior art, the inventor of the present invention based on years of experience in the related industry to conduct experiments and modifications, and finally designed a method for adhering a heat pipe wall and a wick structure in accordance with the present invention to overcome the shortcomings of the prior art.

The present invention is to overcome the shortcomings of the prior art by providing a method for adhering a heat pipe wall and a wick structure that sinters a metal powder and uses the sintered metal powder as an adhesive for the heat pipe wall and wick structure to enhance the effect of adhering the wick structure onto the pipe wall, without affecting the original capillary attraction and transmission of the wick structure.

The present invention provides a method for adhering a heat pipe wall and a wick structure comprising the steps of:

(a) preparing at least one layer of flexible wick structure, and attaching a metal powder onto the wick structure;

(b) placing the wick structure into a hollow heat pipe body, and then supporting the wick structure at an internal wall of the pipe body; and

(c) sintering the metal powder to be used as an adhesive for the pipe body and the wick structure, such that the wick structure is adhered onto an internal wall of the pipe body by the metal powder, and the fibers of the wick structure are cohered with each other by the metal powder.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a flow chart of the present invention; and

FIG. 2 is an enlarged view of a wick structure being adhered with a heat pipe wall according to the present invention.

### DETAILED DESCRIPTION OF THE INVENTION

The technical characteristics, features and advantages of the present invention will become apparent in the following detailed description of the preferred embodiments with reference to the accompanying drawings.

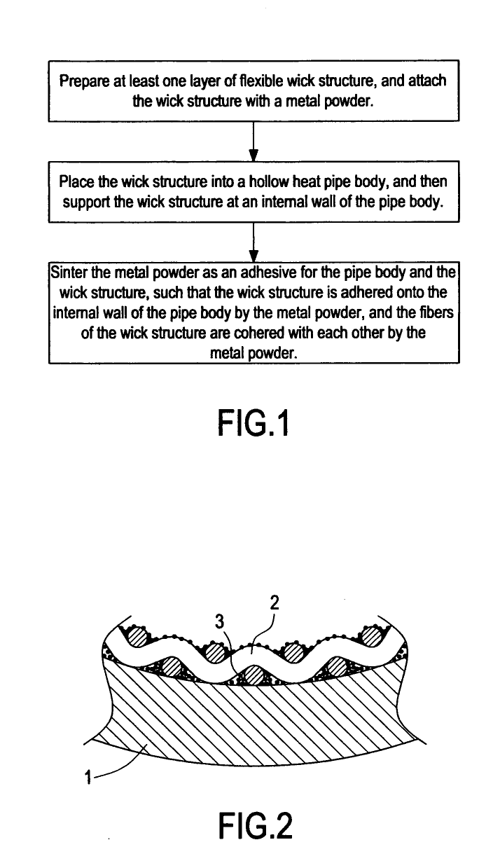

Referring to FIG. 1 for the flow chart of the present invention, the method for adhering a heat pipe wall and a wick structure in accordance with the present invention comprises the steps of:

(a) preparing at least one layer of flexible wick structure, and attaching a metal powder onto the wick structure; wherein the flexible wick structure could be comprised of meshes or fibers, and the metal powder is made of a pure copper, a copper alloy or a tin material, and an appropriate quantity of metal powder is placed upside down or sprayed evenly onto the wick structure or the wick structure is laid flat on the metal powder and the metal power will be attached naturally into the wick structure by slight vertical or horizontal vibrations;

(b) placing the wick structure into a hollow heat pipe body, and supporting the wick structure at an internal wall of the pipe body; wherein the wick structure is coiled to a diameter that can be placed into the heat pipe and then the wick structure is axially put into an opening end of the pipe body, and the restoring capability of the material of the wick structure naturally supports the wick structure at the internal wall of the pipe body, and in the process of coiling the wick structure, the wick structure is coiled on the metal powder, so as to prevent excessive powder from being separated from the wick structure due to the vibration or friction occurred during the processing of placing the wick structure into the pipe body; and

(c) sintering the metal powder to be used as an adhesive for the pipe body and the wick structure, so that the wick structure can be adhered onto the internal wall of the pipe body by the metal powder, and the fibers of the wick structure can be cohered with each other by the metal powder.

By the foregoing arrangement, the method for adhering the heat pipe wall and the wick can be achieved.

Referring to FIG. 2, the granules of metal powder 3 so formed are finer and will be mixed freely into the meshes or fibers of the wick structure before the sintering process. Therefore, uneven, discrete, stacked, or loosened granules of powder will not cause any obstruction to the capillary action. After the sintering process is completed, the wick structure 2 can be adhered at the heat pipe wall 1 and the metal powder becomes a good adhesive. Furthermore, the sintered metal powder 3 is a porous structure, that can enhance the capillary transmission of the meshes or fibers of the wick structure 2, and the fibers of the wick structure 2 can be cohered with each other by the metal powder.

In summation of the above description, the present invention herein enhances the performance than the conventional structure and further complies with the patent application requirements and is submitted to the Patent and Trademark Office for review and granting of the commensurate patent rights.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for adhering a heat pipe wall and a wick structure, comprising the steps of:
(a) preparing at least one layer of flexible wick structure, and attaching the wick structure with a metal powder,
(b) placing the wick structure into a hollow heat pipe body, and then supporting the wick structure at an internal wall of the pipe body; and
(c) sintering the metal powder to be used as an adhesive for the pipe body and the wick structure, thereby the wick structure is adhered onto the internal wall of the pipe body by the metal powder, and fibers of the wick structure are cohered with each other by the metal powder.

2. The method for adhering a heat pipe wall and a wick structure of claim 1, wherein the wick structure of Step (a) comprises a mesh or a fiber.

3. The method for adhering a heat pipe wall and a wick structure of claim 1, wherein the metal power of Step (a) is made of a pure copper, a copper alloy, or a tin material.

4. The method for adhering a heat pipe wall and a wick structure of claim 1, wherein the metal powder of Step (a) is placed upside down or sprayed onto the wick structure.

5. The method for adhering a heat pipe wall and a wick structure of claim 1, wherein the wick structure of Step (a) is laid flat onto the metal powder, and then a portion of the metal powder is attached onto the wick structure by a slight vertical or horizontal vibration.

6. The method for adhering a heat pipe wall and a wick structure of claim 1, wherein the wick structure of Step (b) is coiled into a size with a diameter that can be placed into the pipe body, and then the wick structure is placed into the pipe body, and the wick structure is supported at an internal wall of the pipe body by the restoring capability of the material of the wick structure.

7. The method for adhering a heat pipe wall and a wick structure of claim 6, wherein the wick structure of Step (b) is coiled on the metal power during the process of coiling the wick structure.
